(19) United States
(12) Patent Application Publication
(10) Pub. No.: US 2018/0239654 A1
(43) Pub. Date: Aug. 23, 2018

(54) IMAGE FORMING APPARATUS, MANAGEMENT SERVER, AND INFORMATION PROCESSING METHOD

(71) Applicant: KYOCERA Document Solutions Inc., Osaka (JP)

(72) Inventor: Takashi Araki, Osaka-shi (JP)

(73) Assignee: KYOCERA Document Solutions Inc., Osaka (JP)

(21) Appl. No.: 15/891,820

(22) Filed: Feb. 8, 2018

(30) Foreign Application Priority Data
Feb. 23, 2017 (JP) 2017-031915
Feb. 23, 2017 (JP) 2017-031916

(51) Int. Cl. G06F 9/54; H04N 1/00

(52) U.S. Cl. CPC G06F 9/541; H04N 2201/0094; H04N 1/0097; H04N 1/00344

(57) ABSTRACT

An image forming apparatus includes: a memory that stores a package file including an API execution propriety table and a storage file, propriety of a call and execution of one or more application programming interfaces (APIs) from a program that runs on the image forming apparatus itself being described in the API execution propriety table, the one or more APIs being provided for the program to use a function of the image forming apparatus itself, the storage file storing the program; and a processor that operates as a program execution platform for executing the program, the program execution platform including the one or more APIs and a table check unit, the table check unit checking the API execution propriety table in a case where any of the one or more APIs is called when the program is executed to determine propriety of execution of the called API.

### INCORPORATION BY REFERENCE

This application claims the benefit of Japanese Priority Patent Applications JP 2017-031915 and JP 2017-031916 filed Feb. 23, 2017, the entire contents of which are incorporated herein by reference.

### FIELD

The present disclosure relates to an image forming apparatus, a management server, and an information processing method that manage charging on an API (Application Programming Interface) to be provided.

### BACKGROUND

In recent years, not only services but also APIs such as application programs for providing services are being provided to users. It is possible to create programs that allow the users to call desires functions from the provided APIs for use.

It is desirable to easily manage an API used by a third-party program that runs on an image forming apparatus.

### SUMMARY

An image forming apparatus according to an embodiment of the present disclosure includes: a memory that stores a package file including an API execution propriety table and a storage file, propriety of a call and execution of one or more application programming interfaces (APIs) from a program that runs on the image forming apparatus itself being described in the API execution propriety table, the one or more APIs being provided for the program to use a function of the image forming apparatus itself, the storage file storing the program; and a processor that operates as a program execution platform for executing the program, the program execution platform including the one or more APIs and a table check unit, the table check unit checking the API execution propriety table in a case where any of the one or more APIs is called when the program is executed to determine propriety of execution of the called API.

An information processing method according to an embodiment of the present disclosure includes: by an image forming apparatus, executing a program on a program execution platform for executing the program, the program calling one or more application programming interfaces (APIs) provided to use a function of the image forming apparatus itself; and checking an API execution propriety table in a case where any of the one or more APIs is called to determine propriety of execution of the called API, propriety of a call and execution of the APIs from the program being described in the API execution propriety table.

A management server according to an embodiment of the present disclosure is a management server for packaging a program that runs on an image forming apparatus to distribute the packaged program to an end user and performing charging, the program being developed by a developer, the management server including: a memory that stores a program database and an item code database, the program being registered in the program database using a program ID for uniquely identifying the program as a key, an item code corresponding to the program ID on a one-to-one basis being registered in the item code database using the item code as a key; and a processor that operates as a program registration unit that registers the program in the program database using the program ID of the program as a key, the developer applying for the packaging of the program, an item code issue unit that issues the item code for the program registered in the program database, an API information association unit that associates, on an API execution propriety table, paid API information with the issued item code, propriety of a call and execution of one or more application programming interfaces (APIs) provided by the image forming apparatus from the program being described in the API execution propriety table, the paid API information representing a price for each of the one or more APIs for the program to obtain a right to use the one or more APIs, and a charge unit that charges the developer and/or the end user based on the item code associated with the paid API information.

These and other objects, features and advantages of the present disclosure will become more apparent in light of the following detailed description of best mode embodiments thereof, as illustrated in the accompanying drawings.

### BRIEF DESCRIPTION OF FIGURES

FIG. 1 is a configuration diagram schematically showing a configuration of an image forming apparatus 20;

FIG. 2 is a diagram describing a mechanism of an API call in the image forming apparatus 20 according to an embodiment of the present disclosure;

FIG. 3 is a flowchart describing a processing flow of API call control in the image forming apparatus 20;

FIG. 4 is a configuration diagram in the case where a management server 10 is constituted of a general-purpose computer; and

FIG. 5 is a diagram describing a flow of packaging of a program and charging in the present disclosure.

### DETAILED DESCRIPTION

Hereinafter, an embodiment of the present disclosure will be described with reference to the drawings.

[Overview]

An overview of the present disclosure will be described first.

As a means for solving a problem for an end user, there is a third-party application program (hereinafter, referred to as “program”) for an image forming apparatus, which is installed in the image forming apparatus and activated for use.

There are a number of programs that use many functions of an image forming apparatus. The programs are developed in various places such as sales companies, and provided to end users.

The programs each use a group of many APIs provided from the image forming apparatus to use various functions of the image forming apparatus.

The API group includes those provided as standard and those included in a kit purchased as an option, such as a scan extension kit.

In the following, the scan extension kit and the API group provided by the scan extension kit will be described as an example.

Note that the scan extension kit represents an extension kit incorporated in an image forming apparatus to extend the scan function, e.g., execute OCR processing on the scan data acquired by scanning a document to generate a searchable PDF (Portable Document Format), convert the scan data into a Microsoft Office format, perform barcode recognition, perform marker recognition, provide a zone OCR function, and provide a business card reading function.

In a typical technology, for example, an API in the API group included in the scan extension kit cannot be used unless the scan extension kit is not activated. By activating the scan extension kit, all APIs in the API group can be used, and a menu for using the above-mentioned functions is displayed on an operation panel. Therefore, a user can use functions of the scan extension kit as well as APIs from a program.

However, in the typical technology, even in the case where one function in the scan extension kit is desired to be used via an API, it is necessary to activate the scan extension kit, which causes a problem in cost.

In this embodiment, for example, since the use propriety and charging of each API provided by the scan extension kit can be controlled, it is possible to provide functions to end users at appropriate cost performance.

Note that in this embodiment, a mechanism in which only an API allowed in an image forming apparatus is made available and a mechanism in which an end user who installs a program that uses an API allowed to use in a management server is charged are provided.

The mechanism in which only an API allowed in an image forming apparatus is made available will be described first. After that, the mechanism in which the end user is charged in a management server will be described.

The overview has been described heretofore.

[Configuration of Image Forming Apparatus]

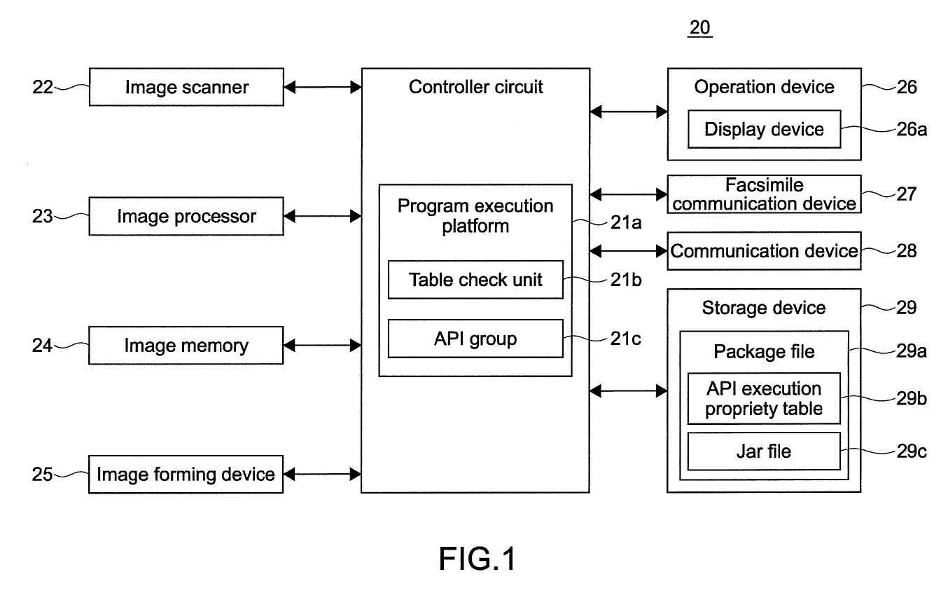

Next, a configuration of an image forming apparatus 20 according to an embodiment of the present disclosure will be described. FIG. 1 is a configuration diagram schematically showing a configuration of the image forming apparatus 20.

The image forming apparatus 20 includes a controller circuit 21. The controller circuit 21 includes a CPU (Central Processing Unit), a RAM (Random Access Memory), a ROM (Read Only Memory), dedicated hardware circuits, and the like and performs overall operational control of the image forming apparatus 20.

The controller circuit 21 is connected to an image scanner 22, an image processor 23, an image memory 24, an image forming device 25, an operation device 26, a display device 26a, a facsimile communication device 27, a communication device 28, a storage device 29, and the like. The controller circuit 21 performs operational control of the respective devices connected thereto and sends/receives signals and data to/from those devices.

According to job execution instructions input by a user via the operation device 26 or a personal computer (PC) connected to a network, the controller circuit 21 controls drive and processing of mechanisms requisite for executing operational control of functions such as a scanner function, a printing function, a copy function, and a facsimile sending/receiving function.

Further, the controller circuit 21 includes a program execution platform 21a. The CPU loads an information processing program recorded in a ROM or the like in a RAM and executes the program to thereby operate as the functional block, i.e., the program execution platform 21a.

The program execution platform 21a is a platform for executing the program on the image forming apparatus 20, and includes a table check unit 21b and an API group 21c.

The table check unit 21b checks an API execution propriety table 29b (to be described later), and controls whether or not the API called from the program executed on the image forming apparatus 20 is to be executed.

The API group 21c is a series of APIs provided by the above-mentioned scan extension kit or the like.

The image scanner 22 reads an image from a document.

The image processor 23 carries out image processing as necessary on image data of an image read by the image scanner 22. For example, the image processor 23 corrects shading of an image read by the image scanner 22 and carries out other image processing to improve the quality of the image to be formed.

The image memory 24 includes an area that temporarily stores data of a document image read by the image scanner 22 or data to be printed by the image forming device 25.

The image forming device 25 forms an image of image data and the like read by the image scanner 22.

The operation device 26 includes a touch panel device and an operation key device that accept user's instructions on various operations and processing executable by the image forming apparatus 20. The touch panel device includes a display device 26a such as an LCD (Liquid Crystal Display) equipped with a touch panel.

The facsimile communication device 27 includes an encoding/decoding device, a modulation/demodulation device, and an NCU (Network Control Unit) (all of which are not shown) and transmits facsimiles using a public telephone network.

The communication device 28 is constituted of a communication module such as a LAN board and sends/receives various types of data to/from apparatuses in the network such as the PC via a LAN connected to the communication device 28, and the like.

The storage device 29 stores a script image read by the image scanner 22, a package file 29a, and the like. The storage device 29 is a large-volume storage device such as an HDD (Hard Disk Drive).

The package file 29a is a file for installing a program in the image forming apparatus 20 and executing the program on the program execution platform 21a, and includes the API execution propriety table 29b and a jar file 29c (storage file).

The API execution propriety table 29b is a table that represents which API among the API group 21c is allowed to use in a program including this table.

The jar file 29c is a file that stores a program to be executed on the program execution platform 21a in a jar (Java Archive) format. Note that since a Java program is assumed as the program to be executed on the image forming apparatus 20, in the package file 29a, a file in a jar format is assumed as a file that stores a program. However, the present disclosure is not limited thereto.

The configuration of the image forming apparatus 20 has been described heretofore.

[Typical API Call]

Next, in order to compare with API use control in this embodiment, a mechanism in which by an API is called from a program in a jar file by using a typical technology will be described.

A third party who is a developer of a program creates an application file first. The application file is a file created in the case of applying for permission to package the program from a manufacturer.

In the application file, program information such as a program ID (Identification) and a program name is described.

Next, the developer who obtains permission of packaging creates a package file. To the package file, a jar file in which a program in a jar format is stored is added in addition to the program information described in the application file.

The package file is provided to an end user by the developer, the manufacturer of the image forming apparatus, or the like, and installed in the image forming apparatus for use.

In the case of executing the installed program, the API group on the program execution platform is called from the program in the jar file.

The mechanism in which by an API is called from a program in a jar file by using a typical technology has been described heretofore.

[API Call in this Embodiment]

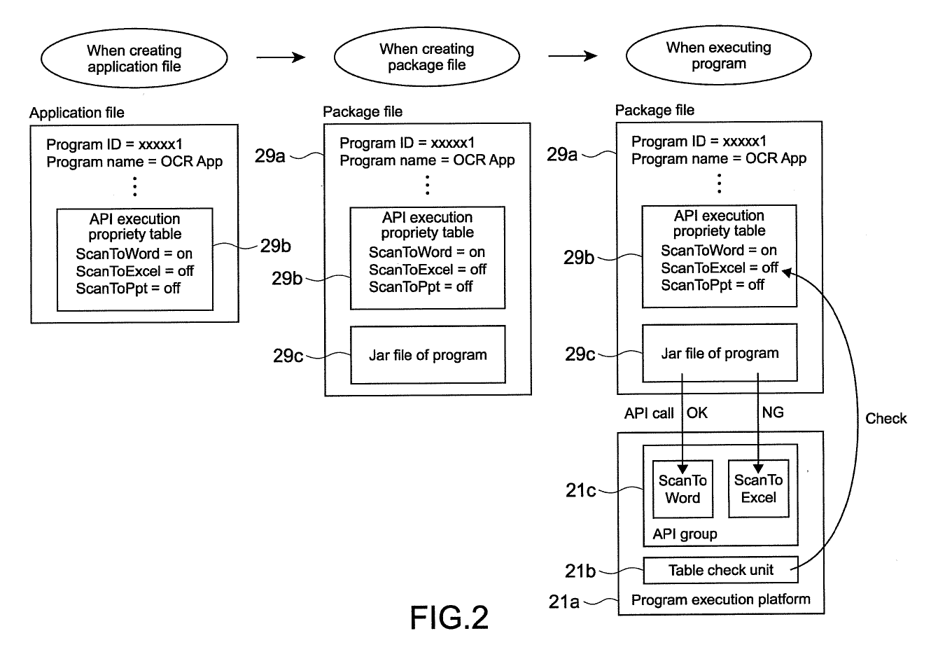

Next, a mechanism of an API call in the image forming apparatus 20 according to an embodiment of the present disclosure will be described. FIG. 2 is a diagram describing a mechanism of an API call in the image forming apparatus 20 according to an embodiment of the present disclosure.

A difference from a typical technology is that the API execution propriety table 29b is added to an application file. With this table, the developer applies for which API a program for which packaging is applied calls.

The API execution propriety table 29b is taken over by the package file 29a, and constitutes the package file 29a together with the program information and the jar file 29c.

In the case of executing the program, when an API in the API group 21c from the program in the jar file is called, the table check unit 21b checks the API execution propriety table 29b in the package file every time, and determines the propriety of the API call.

For example, since an API of ScanToWord is “on” in the API execution propriety table 29b in the example shown in FIG. 2, the table check unit 21b allows the API call, the called API is executed as it is, and the scan data is converted into a WORD (registered trademark) format. Further, since an API of ScanToExcel is “off” in the API execution propriety table 29b, the table check unit 21b does not allow the API call, this API is not executed even in the case where it is called, and an error is returned.

The mechanism of an API call in the image forming apparatus 20 according to an embodiment of the present disclosure has been described heretofore.

[Flow of Processing]

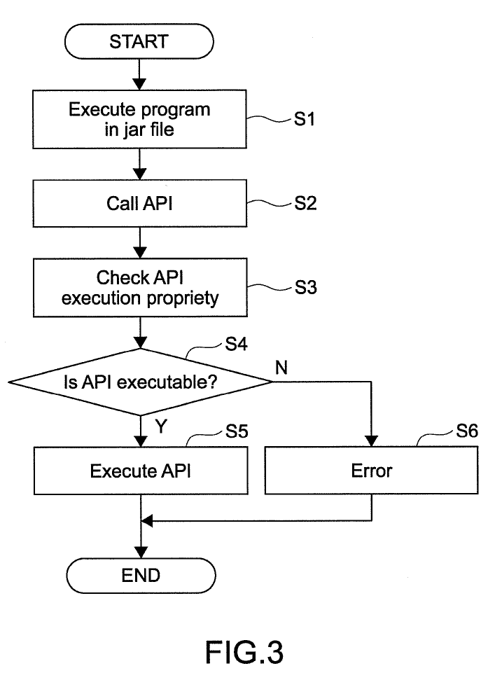

Next, a processing flow of API call control in the image forming apparatus 20 will be described. FIG. 3 is a flowchart describing a processing flow of API call control in the image forming apparatus 20.

First, based on a user instruction, the program execution platform 21a executes a program in the jar file 29c of the package file 29a (Step S1).

Next, the executed program calls an API (Step S2).

Next, the table check unit 21b checks the API execution propriety table 29b in the package file 29a (Step S3).

Next, the table check unit 21b checks, based on the API execution propriety table 29b, whether or not execution of the called API is permitted (Step S4).

In the case where the execution of the API is permitted (Y in Step S4), the called API is executed and the processing is finished (Step S5).

In the case where the execution of the API is not permitted (N in Step S4), the API call gives an error and the processing is finished (Step S5).

The processing flow of API call control in the image forming apparatus 20 has been described heretofore.

[Configuration of Management Server]

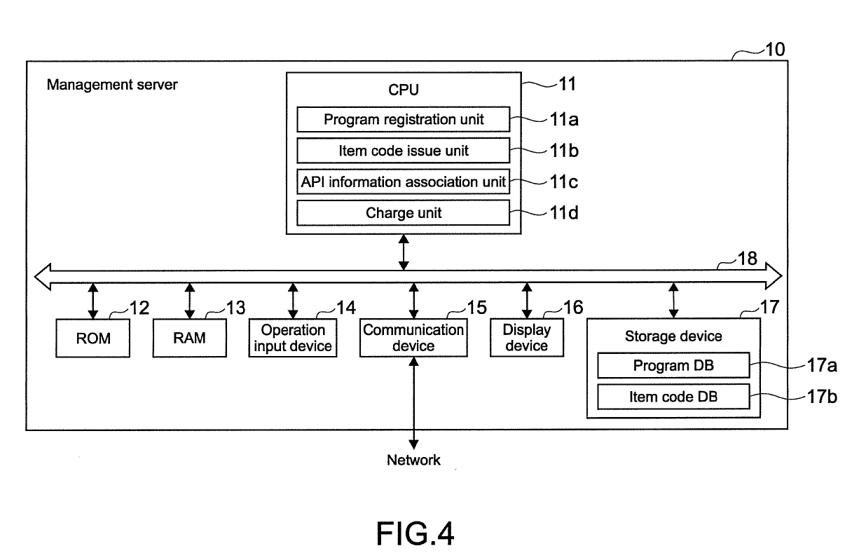

Next, a configuration of a management server 10 that performs charging will be described. The management server 10 may be constituted of dedicated hardware or software, or a general-purpose computer. FIG. 4 is a configuration diagram in the case where the management server 10 is constituted of a general-purpose computer.

As shown in FIG. 4, the management server 10 includes a CPU 11, a ROM 12, a RAM 13, an operation input device 14, a communication device 15, a display device 16, and a storage device 17, and these blocks are connected to each other via a bus 18.

The ROM 12 stores a plurality of programs such as firmware for executing various types of processing, and data. The RAM 13 is used as a work area of the CPU 11 and temporarily stores an OS (Operating System), various applications being executed, and various types of data being processed.

The storage device 17 is, for example, an HDD (Hard Disk Drive), a flash memory, or other nonvolatile memories. The storage device 17 stores the OS, various applications, various types of data, a program DB (Database) 17a, and an item code DB 17b.

The program DB 17a is a database for registering and managing the program developed by the developer. A program ID may be registered as a key.

The item code DB 17b is a database for registering and managing an item code uniquely corresponding to the developed program. The item code is used for charging a use fee for an API usage right for the developer who has developed the program or an end user who installed the developed program for use.

The communication device 15 is connected to a network for sending/receiving information to/from the PC or the like in the network.

Of the plurality of programs stored in the ROM 12 or the storage device 17, the CPU 11 loads a program in the RAM 13 in response to a command input via the operation input device 14, and appropriately controls the display device 16 and the storage device 17 according to the loaded program.

The operation input device 14 is, for example, a pointing device such as a mouse, a keyboard, a touch panel, or other operation devices.

The display device 16 is, for example, a liquid crystal display, an EL (Electro-Luminescence) display, or a plasma display.

Next, functional blocks will be described. When the CPU 11 of the management server 10 executes a program, the CPU 11 operates as the functional blocks described below.

The functional blocks that the CPU 11 of the management server 10 realizes include a program registration unit 11a, an item code issue unit 11b, an API information association unit 11c, and a charge unit 11d.

The program registration unit 11a registers, in the program DB 17a, a program that is developed by the developer, for which packaging is applied, by using a program ID of the program as a key.

The item code issue unit 11b issues an item code to be used for charging, for the program registered in the program DB 17a. Note that the issued item code is registered in the item code DB 17b.

The API information association unit 11c associates the issued item code with paid API information, and registers the associated paid API information in relation to the registered item code in the item code DB 17b. Note that the paid API information represents a price for each API for a program to obtain a right to use each API provided by the API group 21c.

Note that the association may be performed based on the description of the API execution propriety table 29b included in the application file. For example, in the program including the API execution propriety table 29b in which “ScanToWord=on” (off for other APIs) is described, paid API information of “ScanToWord 100 yen” is associated with the item code, and paid API information of “ScanToExcel 150 yen” is not associated with the item code. In this case, the charge unit 11d calculates the actual charge amount by adding up the pieces of paid API information associated with the respective item codes.

The charge unit 11d charges, based on the item code, the developer who has developed a program that calls a specific API and/or an end user who uses the program.

Note that the actual charging may be performed base on the content of the API execution propriety table 29b included in the application file for packaging. In this case, the content of the API execution propriety table 29b may be registered in the item code DB 17b. The charge unit 11d may calculate the actual charge amount based on the content of the API execution propriety table 29b registered in the item code DB 17b with the item code as a key.

For example, in the case where the API use right of “ScanToWord” is defined as 100 yen in the paid API information, the program including the API execution propriety table 29b in which “ScanToWord=on” (off for other APIs) is described charges the user a fee of 100 yen.

The configuration of the management server 10 has been described heretofore.

[Flow of Typical Packaging of Program]

Next, in order to compare with a flow of packaging and charging in this embodiment, a flow of typical packaging of a program will be describe.

First, a developer (sales company for a developer) develops a program that runs on the image forming apparatus 20.

Next, the developer performs an operation test by using an operation check tool provided from a manufacturer of the image forming apparatus 20 to obtain an operation check result. The developer applies for packaging for distributing the developed program with a regional headquarter (hereinafter, referred to as RHQ). The application is performed by attaching the operation check result and the application file.

Next, the RHQ that receives the application for packaging from the developer checks the application content, and then, applies for packaging with the manufacturer of the image forming apparatus 20.

Next, the manufacture of the image forming apparatus 20 that receives the application checks the application content, and then, registers the program in the management server.

Next, the management server issues an item code corresponding to the registered program.

Next, the manufacturer of the image forming apparatus 20 informs the RHQ of the issued item code to permit the packaging.

Next, the RHQ informs the developer of that the packaging is permitted.

Finally, the developer for whom the packaging is permitted creates a package file.

The flow of typical packaging of a program has been described heretofore.

[Flow of Packaging and Charging in this Embodiment]

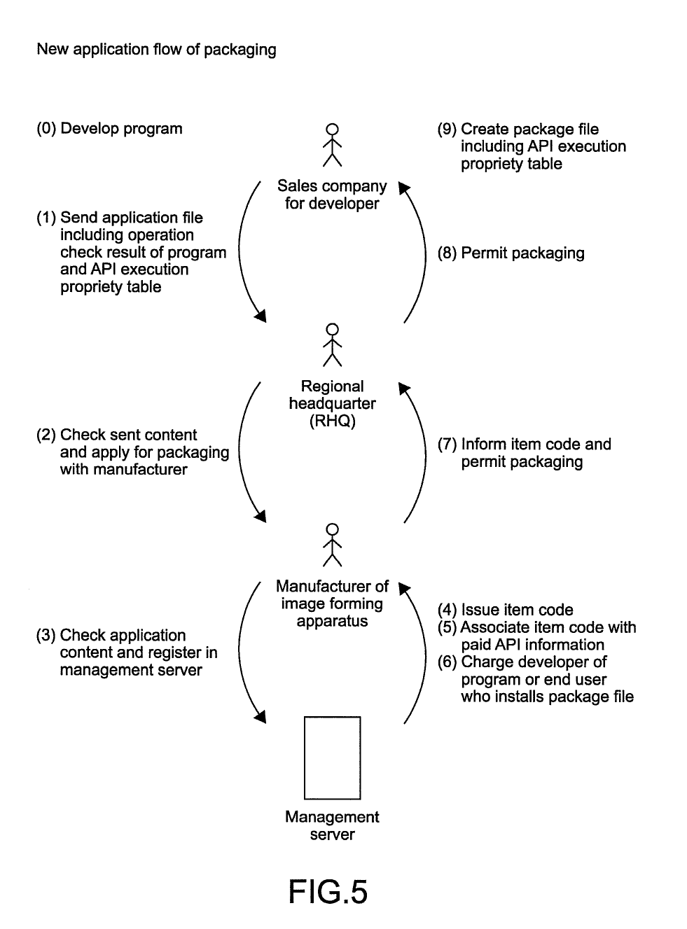

Next, a flow of packaging of a program and charging in this embodiment will be described. FIG. 5 is a diagram describing a flow of packaging of a program and charging in this embodiment.

First, a developer develops a program that runs on the image forming apparatus 20.

Next, the developer performs an operation test by using an operation check tool provided from a manufacturer of the image forming apparatus 20 to obtain an operation check result. The developer applies for packaging for distributing the developed program with an RHQ. The application is performed by attaching the operation check result and the application file. Note that in the application file, the API execution propriety table 29b is described, as described above.

Next, the RHQ that receives the application for packaging from the developer checks the application content, and then, applies for packaging with the manufacturer of the image forming apparatus 20.

Next, the manufacture of the image forming apparatus 20 that receives the application checks the application content, and then, registers the program in the management server with a program ID included in the application content as a key.

Next, the management server issues an item code corresponding to the registered program.

Next, the management server associates the issued item code with paid API information.

Next, the management server charges, on the basis of the item code, the developer of the program and/or an end user who installs the package file.

Next, the manufacturer of the image forming apparatus 20 informs the RHQ of the issued item code to permit the packaging.

Next, the RHQ informs the developer of that the packaging is permitted.

Finally, the developer for whom the packaging is permitted creates a package file including the API execution propriety table 29b.

The flow of packaging of a program and charging in this embodiment has been described heretofore.

[Supplementary Note]

In recent years, not only services but also APIs such as application programs for providing services are being provided to users. It is possible to create programs that allow the users to call desires functions from the provided APIs for use.

For example, according to a possible technology, in order to appropriately manage the actual use of APIs by an application provider and an application user with respect to a service that uses APIs, a service code for uniquely identifying the application provider and license information for uniquely identifying the application user are used. The service code is issued in response to an API use request from an apparatus used by the application provider. The license information is issued for each application user. When performing a service, authentication is performed based on the service code and the license information to permit the API use.

Although this possible technology assumes the API use in an EC(Electronic Commerce) field, it is too complex to be used for charging for an API use by a third-party program that runs on an image forming apparatus (MFP, Multifunction Peripheral).

According to this embodiment, it is possible to easily manage an API used by an application program that runs on an image forming apparatus.

According to this embodiment, it is possible to easily charge for an API use by a third-party program that runs on an image forming apparatus.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus, comprising:
a memory that stores a package file including an API execution propriety table and a storage file, propriety of a call and execution of one or more application programming interfaces (APIs) from a program that runs on the image forming apparatus itself being described in the API execution propriety table, the one or more APIs being provided for the program to use a function of the image forming apparatus itself, the storage file storing the program; and
a processor that operates as a program execution platform for executing the program, the program execution platform including the one or more APIs and a table check unit, the table check unit checking the API execution propriety table in a case where any of the one or more APIs is called when the program is executed to determine propriety of execution of the called API.

2. The image forming apparatus according to claim 1, wherein
the program is created by a third party.

3. The image forming apparatus according to claim 1, wherein
the storage file stores the program in a jar format.

4. An information processing method, comprising:
by an image forming apparatus,
executing a program on a program execution platform for executing the program, the program calling one or more application programming interfaces (APIs) provided to use a function of the image forming apparatus itself; and
checking an API execution propriety table in a case where any of the one or more APIs is called to determine propriety of execution of the called API, propriety of a call and execution of the APIs from the program being described in the API execution propriety table.

5. A management server for packaging a program that runs on an image forming apparatus to distribute the packaged program to an end user and performing charging, the program being developed by a developer, the management server comprising:
a memory that stores a program database and an item code database, the program being registered in the program database using a program ID for uniquely identifying the program as a key, an item code corresponding to the program ID on a one-to-one basis being registered in the item code database using the item code as a key; and
a processor that operates as
a program registration unit that registers the program in the program database using the program ID of the program as a key, the developer applying for the packaging of the program,
an item code issue unit that issues the item code for the program registered in the program database,
an API information association unit that associates, on an API execution propriety table, paid API information with the issued item code, propriety of a call and execution of one or more application programming interfaces (APIs) provided by the image forming apparatus from the program being described in the API execution propriety table, the paid API information representing a price for each of the one or more APIs for the program to obtain a right to use the one or more APIs, and
a charge unit that charges the developer and/or the end user based on the item code associated with the paid API information.

6. The management server according to claim 5, wherein
the API execution propriety table is provided from the developer.
